(19) United States
(12) Patent Application Publication
(10) Pub. No.: US 2014/0017411 A1
(43) Pub. Date: Jan. 16, 2014

(54) PROCESS FOR PRODUCING COMPOSITE MATERIALS

(71) Applicant: BASF SE, Ludwigshafen (DE)

(72) Inventors: Arno Lange, Bad Durkheim (DE); Theo Smit, Heidelberg (DE); Rainer Dyllick-Brenzinger, Ludwigshafen (DE); Gerhard Cox, Bad Durkheim (DE); Oliver Gronwald, Frankfurt (DE); Judith Christine Bräuer, Mannheim (DE); Stefan Spange, Orlamunde (DE); Tina Löschner, Neustadt An Der Weinstrasse (DE); Patrick Kempe, Chemnitz (DE)

(21) Appl. No.: 13/940,835

(22) Filed: Jul. 12, 2013

Related U.S. Application Data
(60) Provisional application No. 61/670,646, filed on Jul. 12, 2012.

(51) Int. Cl. C09D 183/04

(52) U.S. Cl. CPC C09D 183/04
USPC 427/387; 524/588

(57) ABSTRACT

The present invention relates to a process for producing composite materials formed from
a) at least one inorganic or organometallic phase; and
b) at least one organic polymer phase with aromatic or heteroaromatic structural units;
   comprising the homo- or copolymerization of at least one monomer of the formula I

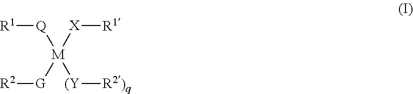

in which
M is a metal or semimetal;
R¹, R² may be the same or different and are each an Ar—C(R^{a},R^{b})— radical in which Ar is as defined in claim 1, or the R¹Q and R²G radicals together are a radical of the formula A

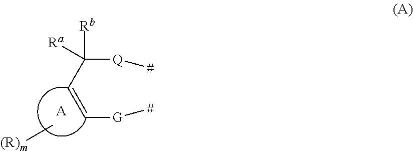

in which A is an aromatic or heteroaromatic ring fused to the double bond, m is 0, 1 or 2, and the R radicals may be the same or different and are as defined in claim 1;
G, Q are each O, S or NH;
Q is O, S or NH; and in which
q, X, Y, R^{1′}, R^{2′} are each as defined in claim 1;
   which comprises performing the polymerization of the monomers of the general formula I thermally in the absence or substantial absence of added catalysts.

The present invention relates to a process for producing composite materials formed from
a) at least one inorganic or organometallic phase; and
b) at least one organic polymer phase with aromatic or heteroaromatic structural units.

Composite materials, i.e. polymer-based composites formed from at least one organic polymer phase and at least one inorganic or organometallic phase, for example an inorganic metal oxide phase, often feature interesting physical, properties, for example mechanical, electrical and/or optical properties.

In recent times, there have been various reports on nanocomposite materials. These are understood to mean composite materials in which the domains of the various phases have dimensions below 500 nm, especially below 100 nm (hereinafter also nanoscale phase or, in the case of a particulate phase, nanoscale particles). Due to the large interface between the nanoscale inorganic or organometallic phase and the organic polymer phase, such materials have a high potential in terms of their chemical, physical and mechanical properties, which cannot be achieved by milli- or microscale dispersions of conventional inorganic constituents in polymer phases (R. P. Singh, et al, J. Mater. Sci. 2002, 37, 781).

The processes known to date for producing inorganic-organic nanocomposites are based on direct mixing of nanoparticles or exfoliated sheet silicates with a polymer in solution or in the melt, the in situ production of the organic phase by polymerizing organic monomers in the presence of inorganic nanoparticles or exfoliated sheet silicates, sol-gel techniques and combinations of these measures (see, for example, for incorporation of nanoparticles into a polymer melt: Garcia, M. et al, Polymers for Advanced Technologies 2004, 15, 164; for polymerization of organic monomers in the presence of inorganic nanoparticles or exfoliated sheet silicates see: M. C. Kuo et al., Materials Chemistry and Physics 2005, 90(1), 185; A. Maity et al., Journal of Applied Polymer Science 2004, 94(2), 803; Y. Liao et al. (Polymer International 2001, 50(2), 207; and WO 2001/012678; for production of an oxide phase by hydrolysis of oligomeric alkoxysiloxanes in a polymer solution or melt see WO 2004/058859 and WO 2007/028563).

The established prior art methods are associated with a number of disadvantages. Firstly, many of them remain restricted to composites of organic polymers which are either soluble in organic solvents or melt without decomposition. In addition, it is generally possible in this way only to introduce small amounts of inorganic phase into the nanocomposite material. Owing to the usually high agglomeration of the nanoparticles and the enormously high shear forces which are necessary as a result, fine distribution of the nanoparticles in any large amount is barely possible. A great disadvantage of nanocomposite production by in situ production of the organic polymer phase in the presence of nanoparticles is the occurrence of formation of nanoparticle agglomerates, such that inhomogeneous products form. This makes it impossible to utilize the advantage of the nanoparticles, that of forming extensive interfaces with the polymer as a result of their large surface area. In the case of use of pulverulent nanofillers, owing to the small particle size, there is additionally a high risk to health during compounding owing to the dust formation which occurs and the ability of the nanoparticles to reach the lungs. The in situ production of the inorganic phase by a sol-gel process in a polymer melt or solution generally leads to poorly reproducible results or requires complex measures to control the hydrolysis conditions.

Spange et al., Angew. Chem. Int. Ed., 46 (2007) 628-632 describe a novel route to nanocomposite materials by acid-catalyzed cationic polymerization of tetrafurfuryloxysilane TFOS and difurfuryloxydimethylsilane. The polymerization of TFOS under cationic, i.e. acidic, conditions forms a composite material which has a silicon dioxide phase and an organic polymer phase composed of polyfurfuryl alcohol PFA. The dimensions of the phase domains in the composite material thus obtained are in the region of a few nanometers. In addition, the phase domains of the silicon dioxide phase and the phase domains of the PFA phase have a co-continuous arrangement, i.e. both the PFA phase and the SiO₂ phase penetrate one another and essentially do not form any discontinuous regions. The distances between adjacent phase interfaces or the distances between the domains of adjacent identical phases are extremely small and are on average not more than 10 nm. Macroscopically visible separation into discontinuous domains of the respective phase occurs only to a minor extent, if at all, in the process described by Spange et al. It is assumed that the specific phase arrangement achieved by the process of Spange et al. and the small distances between adjacent phases are a consequence firstly of the kinetic coupling of the polymerization of the furfuryl units, and secondly of the formation of the silicon dioxide. Consequently, the phase constituents probably form more or less synchronously, and it is assumed that there is a phase separation into the inorganic phase and the organic phase as early as during the polymerization of TFOS. For this reason, the term “twin polymerization” has become established for this polymerization type.

Similar processes for producing nanocomposite materials by twin polymerization are known from WO 2009/083083, WO 2009/133086, WO 2010/128144, WO 2010/112581 and WO 2011/000858. These processes relate to the homo- or copolymerization of at least one monomer from the monomers of the general formula I defined hereinafter, in the presence of acidic catalysts at temperatures of preferably below 120° C.

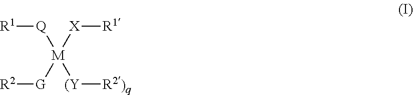

In formula I, the variables M, R¹, R², R^{1′}, R^{2′}, q, q, Q, G, X and Y are each defined as follows:
M is a metal or semimetal, generally a metal or semimetal of main group 3 or 4 or of transition group 4 or 5 of the periodic table, for example B, Al, Si, Ti, Zr, Hf, Ge, Sn, Pb, V, As, Sb or Bi, or B, Si, Ti, Zr or Sn, especially Si or Sn and very especially Si;
R¹, R² are the same or different and are each an Ar—C(R^{a},R^{b})— radical in which Ar is an aromatic or heteroaromatic ring and especially a phenyl ring, where Ar is unsubstituted or optionally has 1 or 2 substituents selected from halogen, CN, C₁-C₆-alkyl, C₁-C₆-alkoxy and phenyl, and R^{a}, R^{b} are each independently hydrogen or methyl or together are an oxygen atom or a methylidene group (═CH₂),
   or the R¹Q and R²G radicals together are a radical of the formula A

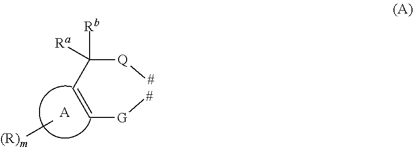

in which A is an aromatic or heteroaromatic ring and especially a benzene ring fused to the double bond, m is 0, 1 or 2, the R radicals may be the same or different and are selected from halogen, CN, C₁-C₆-alkyl, C₁-C₆-alkoxy and phenyl, and Ra, R^{b} are each as defined above;
G is O, S or NH;
Q is O, S or NH;
q according to the valency and charge of M is 0, 1 or 2;
X, Y are the same or different and are each O, S, NH or a chemical bond;
R^{1′}, R^{2′} are the same or different and are each C₁-C₆-alkyl, C₃-C₆-cycloalkyl, aryl or an Ar¹—C(R^{a′},R^{b′})— radical in which Ar′ is as defined for Ar and R^{a′}, R^{b′} are each as defined for R^{a}, R^{b}, or R^{1′}, R^{2′} together with X and Y are a radical of the formula A, as defined above,
   or, when X is oxygen, the R^{1′} radical may also be a radical of the formula:

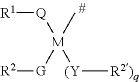

in which q, R¹, R², R^{2′}, Y, Q and G are each as defined above and # is the bond to X.

The prior art twin polymerization processes involving monomers of the formula I afford nanoscale composite materials formed from
a) at least one inorganic or organometallic phase; and
b) at least one organic polymer phase with aromatic or heteroaromatic structural units.

The dimensions of the phase domains in the composite materials thus obtained are generally less than 200 nm and are frequently in the region of a few nanometers, for example not more than 50 nm or not more than 20 nm or not more than 10 nm or not more than 5 nm. In addition, the phase domains of the inorganic or organometallic phase and the phase domains of the organic phase typically have a co-continuous arrangement, i.e. both the organic phase and the inorganic or organometallic phase penetrate one another and essentially do not form any discontinuous regions. The distances between adjacent phase boundaries, or the distances between the domains of adjacent identical phases, are extremely small and are generally on average not more than 200 nm, frequently on average not more than 50 nm or 20 nm and especially on average not more than 10 nm, or not more than 5 nm. There is typically no occurrence of macroscopically visible separation into discontinuous domains of the particular phase in such processes.

The prior art processes for homo- or copolymerization have been found to be particularly disadvantageous when, for example, the monomers of the formula I are homo- or copolymerized in a thin layer. It is possible in this way to produce thin polymer layers. However, the layers thus produced are often defective or have other disadvantages, for example low mechanical stability, unwanted discoloration, inhomogeneous layer thickness, inhomogeneity within the layer or only moderate adhesion on the coated substrate. Moreover, the acid used for catalysis of the polymerization can attack the substrate to be coated and thus lead to further problems.

It has now been found that the aforementioned monomers of the formula I can particularly advantageously be thermally homo- or copolymerized, without any need to add a catalyst. In this way, it is possible to overcome the disadvantages of the prior art. Due to the thermal initiation, it is possible to substantially or completely dispense with the acid catalysis employed in the prior art processes.

Accordingly, the present invention relates to a process for producing composite materials, more particularly to a process for producing nanocomposite materials formed from
a) at least one inorganic or organometallic phase; and
b) at least one organic polymer phase with aromatic or heteroaromatic structural units,
   comprising the homo- or copolymerization of at least one monomer of the formula I as defined above, which comprises performing the polymerization of the monomers of the general formula I thermally in the absence or substantial absence of added catalysts.

In the inventive composite materials, the inorganic or organometallic phase comprises the metal or semimetal M and optionally, when X or Y is a chemical bond, the organic R^{1′} and R^{2′} radicals. The at least one organic polymer phase in turn comprises polymers with aromatic or heteroaromatic structural units which result from the polymerization of the R¹ and R² radicals and optionally, when X and Y are not a chemical bond, of the R^{1′} and R^{2′} radicals.

Surprisingly, the inventive reaction conditions, in spite of the comparatively high temperatures, do not lead to destruction of the nanoscale phase structure achieved for the homo- or copolymerization of the monomers of the formula I under acid catalysis at relatively low temperatures. Instead, the dimensions of the phase domains in the composite materials obtained in accordance with the invention, even in the case of purely thermal initiation with very substantial or complete absence of catalysts, namely acids, are generally less than 200 nm and are frequently in the region of a few nanometers, for example not more than 50 nm or not more than 20 nm or not more than 10 nm or not more than 5 nm.

The advantages of the process according to the invention are evident especially when the monomers of the formula I are homo- or copolymerized in a thin layer. In this way, it is possible to produce thin layers of the composite material which do not have at least some of the disadvantages of the prior art and are especially set apart from the prior art by at least one and preferably more than one or all of the following advantages:
fewer defects within the layer,
improved mechanical stability of the layer,
lower discoloration, if any,
more homogeneous layer thickness,
less inhomogeneity, if any, within the layer,
better adhesion on the coated substrate.

In addition, for performance of the polymerization, the catalytic acid can be substantially or completely dispensed with, and so it is also possible to coat those substrates which are attacked by the acid used for catalysis in the prior art processes.

Accordingly, a preferred configuration of the process according to the invention relates to the production of a coating, which comprises the following steps:
i) applying a layer of at least one monomer of the formula I as defined in claim 1 to a surface to be coated in substantial or complete absence of a catalyst and
ii) triggering a homo- or copolymerization of the at least one monomer of the formula I in the layer by heating the layer.

In this way, a coating in the form of a composite material with the above-mentioned properties is obtained on the coated substrate.

As already explained above, the homo- or copolymerization of the monomers M is triggered thermally, i.e. the polymerization is effected at elevated temperature. The temperature needed for polymerization depends on the stability of the monomers of the formula I, which is determined crucially by the type of metal or semimetal M. The temperature required for the polymerization of the particular monomer can be determined by the person skilled in the art by routine experiments. The temperature required for the polymerization will generally be at least 90° C., particularly at least 100° C. and especially at least 110° C. or at least 120° C. It will preferably not exceed 350° C., particularly 300° C. and especially 250° C.

In the case that M=B, Si or Sn, the temperature needed for polymerization is generally above 160° C., particularly above 170° C. and especially above 180° C., and it is effected preferably at temperatures in the range from 170 to 350° C. and especially at temperatures in the range from 180 to 300° C. or 190 to 250° C.

In the case that M=Al, Pb, As, Sb or Bi, the temperature needed for polymerization is generally above 120° C., particularly above 130° C. and especially above 140° C., and it is effected preferably at temperatures in the range from 120 to 350° C. and especially at temperatures in the range from 130 to 300° C. or 140 to 250° C.

In the case that M=Ti, Zr, Hf, Ge or V, the temperature needed for polymerization is generally above 90° C., particularly above 100° C. and especially above 110° C., and it is effected preferably at temperatures in the range from 90 to 300° C. and especially at temperatures in the range from 100 to 280° C. or 110 to 250° C.

As already explained above, the process according to the invention is performed in the substantial or complete absence of a catalyst. “Very substantial” means that any catalysts are not added at all or are added in an amount of less than 0.05% by weight, particularly less than 0.01% by weight and especially less than 0.005% by weight, based on the monomers of the formula I. Accordingly, in the process according to the invention, the amount of catalyst in the reaction mixture used for polymerization will be less than 0.05% by weight, particularly less than 0.01% by weight and especially less than 0.005% by weight, based on the monomers of the formula I.

Customary catalysts are acids, namely Brønsted acids and Lewis acids. Accordingly, the process according to the invention is performed in the absence or substantial absence of an acid. Accordingly, the process according to the invention relates in particular to the homo- or copolymerization of the monomers of the general formula I in substantial or complete absence of an acid. More particularly, in the process according to the invention, the amount of acid in the reaction mixture used for polymerization will be less than 0.05% by weight, particularly less than 0.01% by weight and especially less than 0.005% by weight, based on the monomers of the formula I.

In the context of the invention, an aromatic radical or aryl is understood to mean a carbocyclic aromatic hydrocarbyl radical such as phenyl or naphthyl.

In the context of the invention, a heteroaromatic radical or hetaryl is understood to mean a heterocyclic aromatic radical which generally has 5 or 6 ring members, where one of the ring members is a heteroatom selected from nitrogen, oxygen and sulfur, and 1 or 2 further ring members may optionally be a nitrogen atom and the remaining ring members are carbon. Examples of heteroaromatic radicals are furyl, thienyl, pyrrolyl, pyrazolyl, imidazolyl, oxazolyl, isoxazolyl, pyridyl or thiazolyl.

In the context of the invention, a fused aromatic radical or ring is understood to mean a carbocyclic aromatic divalent hydrocarbon radical such as o-phenylene (benzo) or 1,2-naphthylene (naphtho).

In the context of the invention, a fused heteroaromatic radical or ring is understood to mean a heterocyclic aromatic radical as defined above, in which two adjacent carbon atoms form the double bond shown in formula A or in the formulae II and III.

Preferred monomers of the formula I for the process according to the invention are those in which M in formula I is selected from the metals and semimetals of main group 3 (IUPAC group 3), especially B or Al, metals and semimetals of main group 4 of the periodic table (IUPAC group 14), especially Si, Ge, Sn or Pb, semimetals of main group 5 of the periodic table (IUPAC group 15), especially As, Sb and Bi, metals of transition group 4 of the periodic table, especially Ti, Zr and Hf, and metals of transition group 5 of the periodic table, such as V. The process according to the invention is especially suitable for polymerization of those monomers of the formula I in which M is selected from the metals and semimetals of main group 4 of the periodic table, especially Si, Ge, Sn or Pb, and metals of transition group 4 of the periodic table, especially Ti, Zr and Hf. The process according to the invention is suitable with particular preference for polymerization of those monomers of the formula I in which M at least in a portion of or the entirety of the monomers is essentially or exclusively silicon. In a likewise very particularly preferred embodiment, M in formula I is boron. In a likewise particularly preferred embodiment, M in formula I is tin.

Preferred monomers of the formula I for the process according to the invention are those in which G and Q in formula I are each oxygen.

Preferred monomers of the formula I for the process according to the invention are those in which X and Y, if present, are each oxygen.

Preferred monomers of the formula I for the process according to the invention are those in which q is 1 and M is selected from Si, Sn and Ti and is especially Si.

Preferred monomers of the formula I for the process according to the invention are also those in which q is 0 and M is B.

In a first embodiment of the monomers of the formula I, the R¹Q and R²G groups together are a radical of the formula A as defined above, especially a radical of the formula Aa:

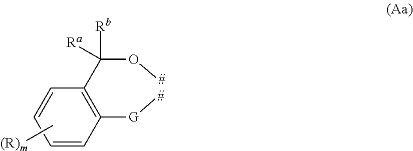

in which #, m, R, R^{a} and R^{b} are each as defined above. In the formulae A and Aa, the variable m is especially 0. When m is 1 or 2, R is especially a methyl or methoxy group. In the formulae A and Aa, R^{a} and R^{b} are especially each hydrogen. In formula A, Q is especially oxygen. In the formulae A and Aa, G is especially oxygen or NH, especially oxygen.

Among the monomers of the formula I, preference is given especially to those compounds in which q=1 and in which the X—R^{1′} and Y—R^{2′} groups together are a radical of the formula A, especially a radical of the formula Aa. Such monomers can be described by the following formulae I-A and I-Aa:

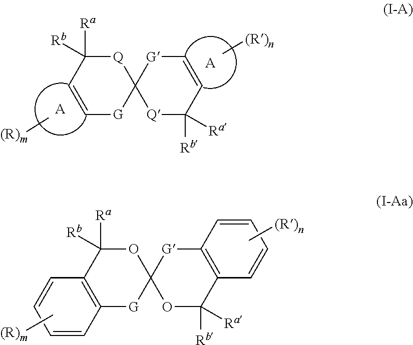

Among the monomers of the formula I, preference is further given to those compounds in which q is 0 or 1 and in which the X—R^{1′} group is a radical of the formula A′ or Aa′:

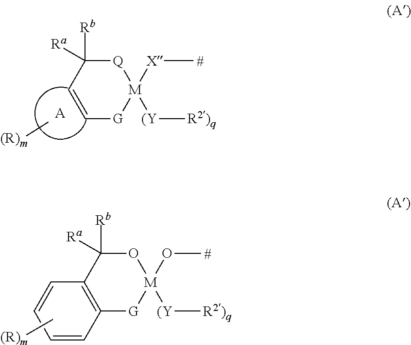

in which m, A, R, R^{a}, R^{b}, G, Q, X″, Y, R^{2′} and q have the aforementioned definitions, especially those specified as preferred.

Such monomers can be described by the following formulae I-A′ and I-Aa′:

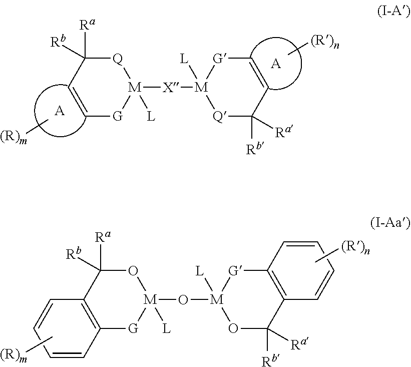

In the formulae I-A and I-A′, the variables are preferably each defined as follows:
M is a metal or semimetal, preferably a metal or semimetal of main group 3 or 4 or of transition group 4 or 5 of the periodic table, especially B, Al, Si, Ti, Zr, Hf, Ge, Sn, Pb, V, As, Sb or Bi, more preferably B, Si or Sn, especially Si;
A, A′ are each independently an aromatic or heteroaromatic ring fused to the double bond;
m, n are each independently 0, 1 or 2, especially O;
G, G′ are each independently O, S or NH, particularly O or NH and especially 0;
Q, Q′ are each independently O, S or NH, especially O;
R, R′ are each independently selected from halogen, CN, C₁-C₆-alkyl, C₁-C₆-alkoxy and phenyl, and are especially each methyl or methoxy;
R^{a}, R^{b}, R^{a′}, R^{b′} are each independently selected from hydrogen and methyl, or R^{a} and R^{b} and/or R^{a′} and R^{b′} in each case together are an oxygen atom or ═CH₂; in particular, R^{a}, R^{b}, R^{a′}, R^{b′} are each hydrogen,
L is a (Y—R^{2′})_{q} group in which Y, R^{2′} and q are each as defined above and
X″ has one of the definitions given for Q and is especially oxygen.

In the formulae I-Aa and I-Aa′, the variables are preferably each defined as follows:
M is a metal or semimetal, preferably a metal or semimetal of main group 3 or 4 or of transition group 4 or 5 of the periodic table, especially B, Al, Si, Ti, Zr, Hf, Ge, Sn, Pb, V, As, Sb or Bi, more preferably B, Si or Sn, especially Si;
m, n are each independently 0, 1 or 2, especially 0;
G, G′ are each independently O, S or NH, particularly O or NH and especially 0;
R, R′ are each independently selected from halogen, CN, C₁-C₆-alkyl, C₁-C₆-alkoxy and phenyl, and are especially each methyl or methoxy;
R^{a}, R^{b}, R^{a′}, R^{b′} are each independently selected from hydrogen and methyl, or R^{a} and R^{b} and/or R^{a′} and R^{b′} in each case together are an oxygen atom or ═CH₂; in particular, Ra, R^{b}, R^{a′}, R^{b′} are each hydrogen,
L is a (Y—R²)_{q} group in which Y, R^{2′} and q are each as defined above.

In the formulae I-A and I-A′, the variables are especially each defined as follows:
M is silicon;
A and A′ are each a benzene ring fused to the double bond;
m and n are each independently 0 or 1;
G and Q are each 0;
R and R′ are the same or different and are each independently selected from halogen, CN, C₁-C₆-alkyl and C₁-C₆-alkoxy; and
R^{a}, R^{b}, R^{a′}, R^{b′} are each hydrogen.

In the formulae I-Aa and I-Aa′, the variables are especially each defined as follows:
M is silicon;
m and n are each independently 0 or 1;
G, G′, Q and Q′ are each 0;
R and R′ are the same or different and are each independently selected from halogen, CN, C₁-C₆-alkyl and C₁-C₆-alkoxy; and
R^{a}, R^{b}, R^{a′}, R^{b′} are each hydrogen.

One example of a monomer of the formula I-A or I-Aa is 2,2′-spirobis[4H-1,3,2-benzodioxasilin] (compound of the formula I-Aa where M=Si, m=n=0, G=O, R^{a}=R^{b}═R^{a′}═R^{b′}=hydrogen). Such monomers are known from WO 2009/083082 and WO 2009/083083 or can be prepared by the methods described therein. A further example of a monomer I-Aa is 2,2-spirobis[4H-1,3,2-benzodioxaborin] (Bull. Chem. Soc. Jap. 51 (1978) 524): (compound of the formula IIa where M=B, m=n=0, G=O, R^{a}═R^{b}=R^{a}′═R^{b′}=hydrogen). A further example of a monomer I-Aa′ is bis(4H-1,3,2-benzodioxaborin-2-yl)oxide (compound of the formula I-Aa′ where M=B, m=n=0, L absent (q=0), G=O, R^{a}═R^{b}═R^{a′}═R^{b′}=hydrogen; Bull. Chem. Soc. Jap. 51 (1978) 524).

In a preferred embodiment, the monomers of the formula Ito be polymerized comprise exclusively the monomers of the formula I-A or I-A′ specified as preferred, especially those of the formula I-Aa or I-Aa′.

In a further preferred embodiment, the monomers of the formula Ito be polymerized comprise at least one first monomer M1 of the formula I-A, especially at least one monomer of the formula I-Aa and at least one second monomer M2 selected from the monomers of the formula I-B, especially of the formula I-Ba:

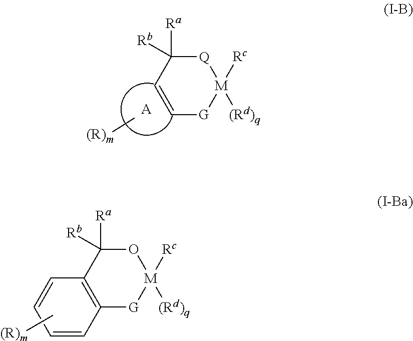

In formula I-B, the variables are preferably each defined as follows:
M is a metal or semimetal, preferably a metal or semimetal of main group 3 or 4 or of transition group 4 or 5 of the periodic table, especially B, Al, Si, Ti, Zr, Hf, Ge, Sn, Pb, V, As, Sb or Bi, more preferably B, Si, Ti, Zr or Sn, especially Si;
A is an aromatic or heteroaromatic ring fused to the double bond and is especially O;
m is 0, 1 or 2, especially 0;
q according to the valency and charge of M is 0, 1 or 2;
G is O, S or NH, particularly O or NH and especially O;
Q is O, S or NH, especially 0;
R are independently selected from halogen, CN, C₁-C₆-alkyl, C₁-C₆-alkoxy and phenyl, and are especially methyl or methoxy;
R^{a}, R^{b} are each independently selected from hydrogen and methyl, or R^{a} and R^{b} together are an oxygen atom or ═CH₂, and both are especially hydrogen;
R^{c}, R^{d} are the same or different and are selected from C₁-C₆-alkyl, C₃-C₆-cycloalkyl and aryl, and are especially each methyl.

In formula I-Ba, the variables are preferably each defined as follows:
M is a metal or semimetal, preferably a metal or semimetal of main group 3 or 4 or of transition group 4 or 5 of the periodic table, especially B, Al, Si, Ti, Zr, Hf, Ge, Sn, Pb, V, As, Sb or Bi, more preferably B, Si, Ti, Zr or Sn, especially Si;
m is 0, 1 or 2, especially 0;
G is O, S or NH, particularly O or NH and especially O;
R are independently selected from halogen, CN, C₁-C₆-alkyl, C₁-C₆-alkoxy and phenyl, and are especially methyl or methoxy;
R^{a}, R^{b} are each independently selected from hydrogen and methyl, or R^{a} and R^{b} together are an oxygen atom or ═CH₂, and both are especially hydrogen;
R^{c}, R^{d} are the same or different and are each selected from C₁-C₆-alkyl, C₃-C₅-cycloalkyl and aryl, and are especially each methyl.

Examples of monomers of the formula I-B or I-Ba are 2,2-dimethyl-4H-1,3,2-benzodioxasilin (compound of the formula I-Ba where M=Si, q=l, m=0, G=O, R^{a}═R^{b}=hydrogen, R^{c}═R^{d}=methyl), 2,2-dimethyl-4H-1,3,2-benzoxazasilin (compound of the formula I-Ba where M=Si, q=l, m=0, G=NH, R^{a}═R^{b}=hydrogen, R^{c}═R^{d}=methyl), 2,2-dimethyl-4-oxo-1,3,2-benzodioxasilin (compound of the formula I-Ba where M=Si, q=l, m=0, G=O, R^{a}+R^{b}═O, R^{c}═R^{d}=methyl) and 2,2-dimethyl-4-oxo-1,3,2-benzoxazasilin (compound of the formula I-Ba where M=Si, q=1, m=0, G=NH, R^{a}+R^{b}═O, R^{c}=R^{d}=methyl). Such monomers are known, for example, from Wieber et al., Journal of Organometallic Chemistry; 1, 1963, 93, 94. Further examples of monomers I-Ba are 2,2-diphenyl[4H-1,3,2-benzodioxasilin] (J. Organomet. Chem. 71 (1974) 225);

2,2-di-n-butyl[4H-1,3,2-benzodioxastannin] (Bull. Soc. Chim. Belg. 97 (1988) 873);

2,2-dimethyl[4-methylidene-1,3,2-benzodioxasilin] (J. Organomet. Chem., 244, C5-C8 (1983)); 2-methyl-2-vinyl[4-oxo-1,3,2-benzodioxazasilin].

In this embodiment, the molar ratio of monomer M1 to the at least one further monomer M2 is generally in the range from 5: 95 to 95: 5, preferably in the range from 10:90 to 90:10, particularly in the range from 15: 85 to 85: 15 and especially in the range from 20:80 to 80:20.

The homo- or copolymerization of the monomers of the formula I can be performed in bulk or in an inert diluent.

The aprotic organic solvents include, in particular, hydrocarbons which may be aliphatic, cycloaliphatic or aromatic, and mixtures thereof with halogenated hydrocarbons. Preferred solvents are hydrocarbons, for example acyclic hydrocarbons having generally 4 to 16 and preferably 3 to 8 carbon atoms, especially alkanes such as n-butane and isomers thereof, n-pentane and isomers thereof, n-hexane and isomers thereof, nheptane and isomers thereof, and also n-octane, n-decane and isomers thereof, ndodecane and isomers thereof, n-tetradecane and isomers thereof and n-hexadecane and isomers thereof, and additionally cycloalkanes having 5 to 16 carbon atoms, such as cyclopentane, methylcyclopentane, cyclohexane, methylcyclohexane, cycloheptane, cyclooctane, decalin, cyclododecane, biscyclohexylmethane, aromatic hydrocarbons such as benzene, toluene, xylenes, mesitylene, ethylbenzene, cumene (2-propylbenzene), isocumene (1-propylbenzene), tert-butylbenzene, isopropylnaphthalene or diisopropylnaphthalene.

Preference is also given to mixtures of the aforementioned hydrocarbons with halogenated hydrocarbons, such as halogenated aliphatic hydrocarbons, for example such as chloromethane, dichloromethane, trichloromethane, chloroethane, 1,2-dichloroethane and 1,1,1-trichloroethane and 1-chlorobutane, and also halogenated aromatic hydrocarbons such as chlorobenzene, 1,2-dichlorobenzene and fluorobenzene. Preferably, the proportion of the hydrocarbons in the mixtures is at least 50% by volume, particularly at least 80% by volume and especially at least 90% by volume, based on the total amount of organic solvent.

In a preferred embodiment of the invention, the organic solvent used for polymerization comprises at least one aromatic hydrocarbon, especially at least one alkylaromatic, in particular mono-, di- or trialkylbenzenes and mono-, di- or trialkylnaphthalenes, e.g. toluene, xylene and xylene mixtures, 1,2,4-trimethylbenzene, mesitylene, ethylbenzene, cumene, isocumene, tert-butylbenzene, isopropylnaphthalene or diisopropylnaphthalene, and mixtures of these solvents. In this embodiment, the organic solvent comprises the aromatic hydrocarbon, especially alkylaromatics, preferably in an amount of at least 50% by volume, particularly at least 80% by volume and especially at least 90% by volume, based on the total amount of organic solvent. The remaining amount of organic solvents is selected in this embodiment preferably from alkanes and cycloalkanes.

Preference is given particularly to those aprotic organic solvents whose boiling point at standard pressure is above 130° C. and especially above 150° C. or above 200° C. These particularly include high-boiling aromatic hydrocarbons such as mono-, di- or trialkylbenzenes and mono-, di- or trialkylnaphthalenes, e.g. diisopropylnaphthalene.

When the reaction is performed in bulk, the concentration of monomer in the diluent is in the range from 1 to 500 g/l and especially in the range from 10 to 300 g/l.

Reaction in a solvent or diluent allows, in a simple manner, the production of particulate composite material with very small particle sizes. More particularly, the mean particle size of the particulate composite material thus produced (weight average of the primary particles, determined by light scattering on diluted samples) is typically in the range from 5 nm to 1 μm and especially in the range from 10 to 500 nm.

In another embodiment of the invention, the homo- or copolymerization of the monomers of the formula I is conducted in bulk, i.e. in a melt of the monomers of the formula I, in which case the melt may optionally comprise up to 20% by weight and especially up to 10% by weight of an inert diluent.

Preference is given to performing the polymerization of the monomers of the formula I in the substantial absence of water, which means that the concentration of water at the start of the polymerization is less than 0.1% by weight. Accordingly, preferred monomers of the formula I are those monomers which do not release any water under polymerization conditions. These include especially the monomers of the formulae I-A, I-Aa, I-A′, I-Aa′, I-B and I-Ba.

The polymerization of the compounds of the formula I may be followed by purification steps and optionally drying steps. For example, the polymerization product obtained in the polymerization can be added to a suitable diluent in order to remove unreacted monomer and/or high-boiling solvent.

The polymerization of the compounds of the formula I may be followed by a calcination. This involves carbonizing the organic polymeric material formed in the polymerization of the monomer unit(s) B to give the carbon phase. For further details, reference is made here to the prior art cited at the outset regarding the polymerization of monomers of the formula I.

The polymerization of the compounds of the formula I may be followed by an oxidative removal of the organic polymer phase. This involves oxidizing the organic polymeric material formed in the polymerization of the organic constituents to obtain a nanoporous oxidic, sulfidic or nitridic material. For further details, reference is made here to the prior art cited at the outset regarding the polymerization of monomers of the formula I.

As already explained above, a particular configuration of the process according to the invention relates to the production of a coating. For this purpose, a thin layer of the monomers of the formula I will be polymerized. This monomer layer is typically applied to the surface to be coated prior to the polymerization.

The monomers of the formula I can be applied in a manner known per se. In general, the monomers of the formula I will be applied to the surface to be coated in liquid form, for example in the form of a melt or in the form of a solution in a suitable diluent.

When the monomers of the formula I are applied to the surface to be coated in the form of a solution, the diluent will preferably be removed prior to the polymerization. The diluent is therefore preferably a volatile organic solvent whose boiling point at standard pressure preferably does not exceed 120° C. and is especially in the range from 40 to 120° C. Examples of suitable organic solvents for this purpose are halogenated hydrocarbons such as dichloromethane, trichloromethane, dichloroethane, aromatic hydrocarbons such as toluene, ethers such as diethyl ether, diisopropyl ether or methyl tert-butyl ether.

The monomers of the formula I will preferably be applied to the surface to be coated in an amount of 0.1 to 5000 g/m², particularly in an amount of 1 to 1000 g/m² and especially 5 to 500 g/m². In this way, coatings are obtained in a thickness of 0.1 to 5000 μm, particularly in the range of 1 to 1000 μm, especially 5 to 500 μm.

The substrates to be coated are suitably thermally stable. Examples of suitable substrates are metals, glass, ceramic, and polymeric materials of high thermal stability.

In the composite materials obtained by the process according to the invention, the inorganic or organometallic phase comprises the metal or semimetal M and optionally, when X or Y is a chemical bond, the organic R^{1′} and R^{2′} radicals. The at least one organic polymer phase in turn comprises polymers with aromatic or heteroaromatic structural units which result from the polymerization of the R¹ and R² radicals and optionally, when X and Y are not a chemical bond, of the R^{1′} and R^{2′} radicals.

As already explained above, the dimensions of the phase domains in the composite materials obtained in accordance with the invention are generally less than 200 nm and are frequently in the region of a few nanometers, for example not more than 50 nm or not more than 20 nm or not more than 10 nm or not more than 5 nm. However, it is possible to obtain materials with domain sizes up to 100 to 200 nm. In addition, the phase domains of the inorganic or organometallic phase and the phase domains of the organic phase in the composite materials obtained in accordance with the invention generally have a co-continuous arrangement, i.e. both the organic phase and the inorganic or organometallic phase penetrate one another and essentially do not form any discontinuous regions. The distances between adjacent phase boundaries, or the distances between the domains of adjacent identical phases, are extremely small here and are generally on average not more than 200 nm, frequently on average not more than 50 nm or 20 nm and especially on average not more than 10 nm, or not more than 5 nm. However, it is possible to obtain materials with domain sizes up to 100 to 200 nm. There is typically no occurrence of macroscopically visible separation into discontinuous domains of the particular phase in the process according to the invention.

The mean distance between the domains of adjacent identical phases can be determined by means of combined small-angle X-ray scattering (SAXS) via the scatter vector q (measurement in transmission at 20° C., monochromatized CuK_{α} radiation, 2D detector (image plate), slit collimation).

With regard to the terms “continuous phase domain”, “discontinuous phase domain” and “co-continuous phase domain”, reference is also made to W. J. Work et al., Definitions of Terms Related to Polymer Blends, Composites and Multiphase Polymeric Materials, (IUPAC Recommendations 2004), Pure Appl. Chem., 76 (2004), p. 1985-2007, especially p. 2003. According to this, a co-continuous arrangement of a two-component mixture is understood to mean a phase-separated arrangement of the two phases, in which within one domain of the particular phase a continuous path through either phase domain may be drawn to all phase boundaries without crossing any phase domain boundary.

The composite materials obtainable in accordance with the invention can be converted in a manner known per se to nanoporous inorganic materials, by oxidatively removing the organic constituents of the composite material obtained in accordance with the invention. This preserves the nanostructure of the inorganic or organo(semi)metallic phase present in the composite material obtained in accordance with the invention, and the result, depending on the monomers of the formula I selected, is an oxide or nitride of the (semi)metal or a mixed form. The oxidation is effected typically by heating in an oxygenous atmosphere as described in the article by Spange et al. cited at the outset. In general, heating is effected with ingress of oxygen at a temperature in the range from 400 to 1500° C., especially in the range from 500 to 1000° C. The heating is typically effected in an oxygenous atmosphere, for example in air or other oxygen/nitrogen mixtures, the proportion by volume of oxygen being variable over wide ranges and being, for example, in the range from 5 to 50% by volume.

The composite materials obtainable in accordance with the invention can also be converted to an electrically active composite material which, as well as an inorganic phase of a (semi)metal, which may be either oxidic or (semi)metallic, has a carbon phase C. Such materials are obtainable by calcining the composite material obtainable in accordance with the invention with substantial or complete exclusion of oxygen. In the carbonaceous nanocomposite material, a carbon phase C and the inorganic phase essentially form the above-described phase arrangement. In general, the calcination is performed at a temperature in the range from 400 to 2000° C., especially in the range from 500 to 1000° C. The calcination is then typically effected with substantial exclusion of oxygen. In other words, during the calcination, the partial oxygen pressure in the reaction zone in which the calcination is performed is low, and will preferably not exceed 20 mbar, especially 10 mbar. Preference is given to performing the calcination in an inert gas atmosphere, for example under nitrogen or argon. The inert gas atmosphere will preferably comprise less than 1% by volume, especially less than 0.1% by volume, of oxygen. In a likewise preferred embodiment of the invention, the calcination is performed under reducing conditions, for example in an atmosphere which comprises hydrogen (H2), hydrocarbon gases such as methane, ethane or propane, or ammonia (NH₃), optionally as a mixture with an inert such as nitrogen or argon. To remove volatile constituents, the calcination can be performed in an inert gas stream or in a gas stream which comprises reducing gases such as hydrogen, hydrocarbon gases or ammonia.

The examples and figures which follow are intended to illustrate the invention.

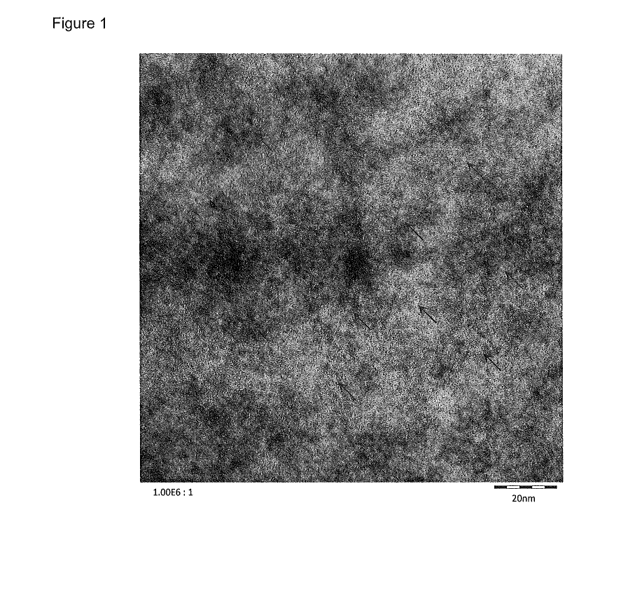

FIG. 1: TEM image (10⁶: 1) of a sample of the monolith obtained from example 1

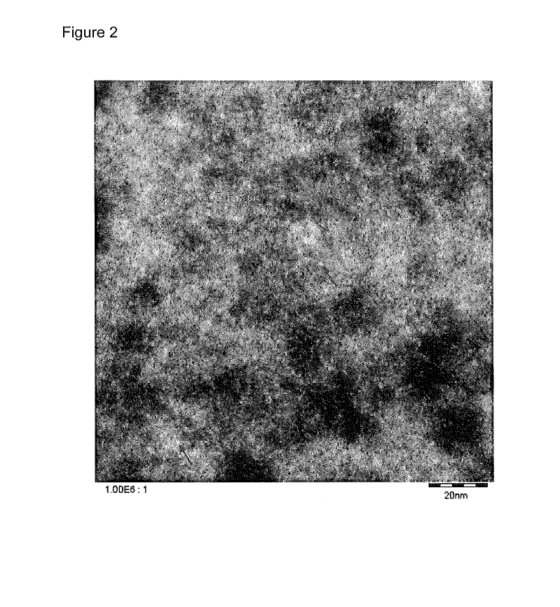

FIG. 2: TEM image (10⁶: 1) of a sample of the powder obtained from example 2

### I. ANALYSIS

The samples obtained in the polymerization were analyzed by means of TEM: the TEM analyses were performed as HAADF-STEM with a Tecnai F20 transmission electron microscope (FEI, Eindhoven, the Netherlands) at a working voltage of 200 kV using ultrathin layer methodology (embedding of the samples into synthetic resin as a matrix). The results are shown in FIGS. 1 and 2 which follow. Arrows in the figures indicate particularly characteristic regions of the sample, which show that the domain distances are in the region of a few nm (<10 nm).

### II) MONOMERS USED

The following monomers were used:

Monomer A: 2,2′-spirobis[4H-1,3,2-benzodioxasilin]: preparation example 1;

Monomer B: 2,2-dimethyl[4H-1,3,2-benzodioxasilin]: Tetrahedron Lett. 24 (1983) 1273;

### III) PREPARATION EXAMPLES

### Preparation Example 1

### 2,2′-spirobis[4H-1,3,2-benzodioxasilin] (monomer A)

135.77 g of salicyl alcohol (1.0937 mol) were dissolved in toluene at 85° C. Subsequently, 83.24 g (0.5469 mol) of tetramethoxysilane (TMOS) were slowly added dropwise, in the course of which, after addition of one third of the TMOS, 0.3 ml of tetra-n-butylammonium fluoride (1 M in THF) was injected all at once. The mixture was stirred at 85° C. for 1 h and then the methanol/toluene azeotrope was distilled off (63.7° C.). The remaining toluene was removed on a rotary evaporator. The product was removed by dissolution from the resulting reaction mixture with hexane at≈70° C. After cooling to 20° C., the clear solution was decanted off. After removing the hexane, the title compound remained as a white solid. The product can be purified further to remove impurities by reprecipitation with hexane.

¹H NMR (400 MHz, CDCl₃, 25° C., TMS) δ [ppm]=5.21 (m, 4H, CH₂), 6.97-7.05 (m, 6H), 7.21-7.27 (M, 2H).

¹³C NMR (100 MHz, CDCl₃, 25° C.): δ [ppm]=66.3 (CH₂), 119.3, 122.3, 125.2, 125.7, 129.1, 152.4.

²⁹Si CP-MAS (79.5 MHz): δ [ppm]=−78.4

### Polymerization Example 1

### Polymerization of Monomer A in Bulk

Monomer A (7.923 g, 0.029 mol) was heated to 200° C. in a 100 ml glass flask with reflux cooling. The viscosity of the melt increased gradually and a transparent monolith formed after about 1 h. The reaction mixture was left to cool under argon and the monolith thus obtained was analyzed by means of TEM.

### Polymerization Example 2

### Polymerization of Monomer a in Solution

Under a gentle argon stream, 3.74 g (0.013 mol) of monomer A were dissolved in 50 ml of diisopropylnaphthalene in a reaction vessel with a reflux condenser (c=74.76 g/l). Subsequently, the mixture was heated to reflux at 220° C. under argon. After 1 h, the mixture was left to cool under argon, in the course of which the reaction fluid became slightly turbid. A turbid dispersion was obtained, in which the solids did not separate sufficiently from the liquid phase. The dispersion was added dropwise to 130 ml of hexane while stirring. After 1 h, the particles present settled out and the liquid hexane phase was cautiously decanted off. The particulate product obtained was then washed repeatedly with hexane. After drying, virtually colorless to pale yellowish product was obtained as a fine powder (dust).

The powder consisted of agglomerated polymer particles of a phenol resin-silicon dioxide with agglomerate sizes of 200 nm to 1.5 μm. The primary particles discernible in the TEM had diameters in the range from ˜20 to 50 nm. The domain sizes (determined by HSTEM) were about 2 to 3 nm (see FIG. 2).

### Polymerization Example 3

### Polymerization of Monomer a in Solution

Under a gentle argon stream, 5.53 g (0.020 mol) of monomer A were dissolved in 180 ml of diisopropylnaphthalene in a reaction vessel with a reflux condenser (c=30.72 g/l). Subsequently, the mixture was heated to reflux at 220° C. under argon. After 2 h, the mixture was left to cool under argon, and a clear orange liquid was obtained. The liquid thus obtained was added dropwise to 500 ml of hexane while stirring. After stirring for 1 h, the particles present settled out and the clear hexane phase was cautiously decanted off. Hexane was added again, the hexane was decanted off, and this procedure was repeated several times. The solids thus obtained were then washed repeatedly with hexane. After drying, virtually colorless to pale yellowish product was obtained as a fine powder (dust).

The powder consisted of agglomerated polymer particles of a phenol resin-silicon dioxide with agglomerate sizes of 200 nm to 1.5 μm. The primary particles discernible in the TEM had diameters in the range from ˜20 to 50 nm. The domain sizes (determined by HSTEM) were about 2 to 3 nm.

### Polymerization Example 4

### Polymerization of Monomer a in Solution

Polymerization was effected in analogy to example 2, using a solution of 5.79 g (0.021 mol) of monomer A in 38.6 ml of diisopropylnaphthalene (c=149.96 g/l). After cooling, a solid product was obtained, which was diluted with 50 ml of trichloromethane and stirred for 1 h. Subsequently, the solids were filtered off and suspended in acetone, the suspension was stirred again for 1 h and the solids were filtered off again. In this way, after drying, virtually colorless to pale yellowish product was obtained as a fine powder (dust).

The powder consisted of agglomerated polymer particles of a phenol resin-silicon dioxide with agglomerate sizes of 200 nm to 1.5 μm. The primary particles discernible in the TEM had diameters in the range from ˜20 to 50 nm. The domain sizes (determined by HSTEM) were about 2 to 3 nm.

Polymerization example 5: copolymerization of monomers A and B in bulk 4.313 g of monomer A and 2.855 g of monomer B were initially charged in a Teflon vessel (closed, argon atmosphere). The reaction mixture was at first heated to 85° C. while stirring, until a clear melt formed. Subsequently, the reaction temperature was increased to 200° C. within a period of 3.5 h and kept at 200° C. argon atmosphere for a further 2 h. Thereafter, the mixture was heated to 200° C. with ingress of air for a further 4 h. This gave a transparent solid which was dark brown on the outside, due to the ingress of air, and pale yellowish on the inside.

According to elemental analysis, the polymer had the composition expected for a phenol resin/silicon dioxide composite. According to differential thermoanalysis (DSC), the conversion was complete.

### Polymerization Example 6

### Polymerization of Monomer a in a Thin Layer

A solution of monomer A in toluene (5% by weight) was applied with a 10 μm coating bar to a galvanized steel sheet. After drying at room temperature, the SBS-coated sheet was heated at 200° C. for 2 minutes in order to thermally polymerize monomer A. The coating thus obtained could not be washed off with toluene and is thus resistant to contact with toluene.

1-18. (canceled)

19. A process for producing a composite material composed of
a) at least one inorganic or organometallic phase; and
b) an organic polymer phase with aromatic or heteroaromatic structural units;
comprising the homo- or copolymerization of at least one monomer of the formula I 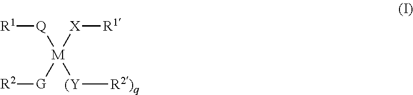
in which
M is a metal or semimetal;
R¹ and R² may be the same or different and are each an Ar—C(R^{a},R^{b})— radical in which Ar is an aromatic or heteroaromatic ring which optionally has 1 or 2 substituents selected from halogen, CN, C₁-C₆-alkyl, C₁-C₆-alkoxy and phenyl, and
R^{a} and R^{b} are each independently hydrogen or methyl or together are an oxygen atom or a methylidene group (═CH₂), or
the R¹Q and R²G radicals together are a radical of the formula A 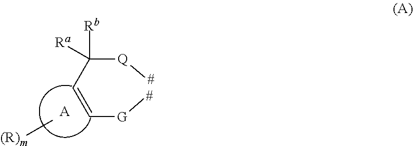
in which A is an aromatic or heteroaromatic ring fused to the double bond, m is 0, 1 or 2, the R radicals may be the same or different and are selected from halogen, CN, C₁-C₆-alkyl, C₁-C₆-alkoxy and phenyl, and R^{a} and R^{b} are each as defined above;
G is O, S or NH;
Q is o, S or NH;
q according to the valency and charge of m is 0, 1 or 2;
X and Y may be the same or different and are each O, S, NH or a chemical bond;
R^{1′} and R^{2′} may be the same or different and are each C₁-C₆-alkyl, C₃-C₆-cycloalkyl, aryl or an Ar′—C(R^{a′},R^{b′})— radical in which Ar′ is as defined for Ar and R^{a′}, R^{b′} are each as defined for R^{a}, R^{b}, or R^{1′}, R^{2′} together with X and Y are a radical of the formula A, as defined above,
or, when X is oxygen, the R^{1′} radical may be a radical of the formula: 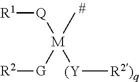
in which q, R¹, R², R^{2′}, Y, Q and G are each as defined above and # is the bond to X;
which comprises performing the polymerization thermally in substantial or complete absence of a catalyst.

20. The process according to claim 19, wherein the polymerization is performed at a temperature above 90° C.

21. The process according to claim 19, wherein the polymerization is performed in substantial or complete absence of acids.

22. The process according to claim 21, wherein the amount of acid in the reaction mixture used for polymerization is less than 0.05% by weight, based on the monomers of the formula I.

23. The process according to claim 19, wherein the metal or semimetal M in formula I is selected from the group consisting of B, Al, Si, Ti, Zr, Hf, Ge, Sn, Pb, V, As, Sb and Bi.

24. The process according to claim 19, wherein G and Q in formula I are each oxygen.

25. The process according to claim 19, wherein the monomers of the formula Ito be polymerized have at least one monomer unit A.

26. The process according to claim 25, wherein the monomers of the formula Ito be polymerized comprise at least one monomer of the general formula I-A: 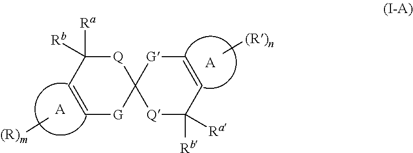
in which
M is a metal or semimetal;
A and A′ are each an aromatic or heteroaromatic ring fused to the double bond;
m and n are each independently 0, 1 or 2;
G and G′ are the same or different and are each independently O, S or NH;
Q and Q′ are the same or different and are each independently O, S or NH;
R and R′ are the same or different and are each independently halogen, CN, C₁-C₆-alkyl, C₁-C₆-alkoxy or phenyl; and
R^{a}, R^{b}, R^{a′} and R^{b′} are each independently selected from hydrogen and methyl, or R^{a} and R^{b} and/or R^{a′} and R^{b′} in each case together are an oxygen atom or a methylidene group.

27. The process according to claim 26, wherein the monomers to be polymerized comprise at least one first monomer M1 of the formula I-A and at least one second monomer M2 selected from the monomers of the formula I-B: 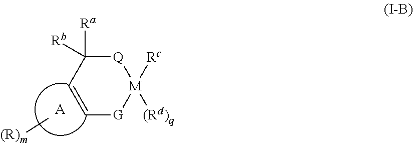
in which
M is a metal or semimetal;
A is an aromatic or heteroaromatic ring fused to the double bond;
m is 0, 1 or 2;
q according to the valency and charge of m is 0, 1 or 2;
G is O, S or NH;
Q is o, S or NH;
R is independently selected from halogen, CN, C₁-C₆-alkyl, C₁-C₆-alkoxy and phenyl;
R^{a} and R^{b} are each independently selected from hydrogen and methyl, or R^{a} and R^{b} together are an oxygen atom or a methylidene group, and
R^{c} and R^{d} are the same or different and are each selected from C₁-C₆-alkyl, C₃-C₆-cycloalkyl and aryl.

28. The process according to claim 26, wherein, in formula I-A:
M is silicon;
A and A′ are each a benzene ring fused to the double bond;
m and n are each independently 0 or 1;
G, G′, Q and Q′ are each O;
R and R′ are the same or different and are each independently a halogen, CN, C₁-C₆-alkyl or C₁-C₆-alkoxy; and
R^{a}, R^{b}, R^{a′}, R^{b} are each hydrogen.

29. The process according to claim 19, wherein the polymerization of the monomers of the formula I is performed in a solution of the monomer of the formula I in an aprotic organic solvent or solvent mixture.

30. The process according to claim 19, wherein the polymerization of the monomers of the formula I is performed in bulk.

31. The process according to claim 19, wherein a thin layer of the monomers of the formula I is polymerized.

32. A process for producing a coating, comprising:
i) applying a layer of at least one monomer of the formula I 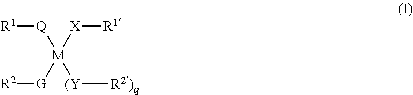
in which
M is a metal or semimetal;
R¹ and R² may be the same or different and are each an Ar—C(R^{a},R^{b})— radical in which Ar is an aromatic or heteroaromatic ring which optionally has 1 or 2 substituents selected from halogen, CN, C₁-C₆-alkyl, C₁-C₆-alkoxy and phenyl, and
R^{a} and R^{b} are each independently hydrogen or methyl or together are an oxygen atom or a methylidene group (═CH₂), or
the R¹Q and R²G radicals together are a radical of the formula A 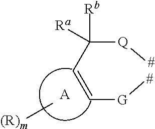
in which A is an aromatic or heteroaromatic ring fused to the double bond, m is 0, 1 or 2, the R radicals may be the same or different and are selected from halogen, CN, C₁-C₆-alkyl, C₁-C₆-alkoxy and phenyl, and R^{a} and R^{b} are each as defined above;
G is O, S or NH;
Q is o, S or NH;
q according to the valency and charge of m is 0, 1 or 2;
X and Y may be the same or different and are each O, S, NH or a chemical bond;
R^{1′} and R^{2′} may be the same or different and are each C₁-C₆-alkyl, C₃-C₆-cycloalkyl, aryl or an Ar′—C(R^{a′},R^{b′})— radical in which Ar′ is as defined for Ar and R^{a′}, R^{b′} are each as defined for R^{a}, R^{b}, or R^{1′}, R^{2′} together with X and Y are a radical of the formula A, as defined above,
or, when X is oxygen, the R^{1′} radical may be a radical of the formula: 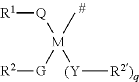
in which q, R¹, R², R^{2′}, Y, Q and G are each as defined above and # is the bond to X;
to a surface to be coated in substantial or complete absence of a catalyst and
ii) triggering a homo- or copolymerization of the at least one monomer of the formula I in the layer by heating the layer.

33. The process according to claim 32, wherein the layer is heated to a temperature above 90° C.

34. The process according to claim 32, wherein the polymerization is performed in substantial or complete absence of an acid.

35. The process according to claim 32, wherein the polymerization of the monomers of the formula I is performed in bulk.

36. The process according to claim 32, wherein the monomers of the formula I are applied to the surface to be coated in an amount of 1 to 2000 g/m².
